(19) United States
(12) Patent Application Publication
(10) Pub. No.: US 2024/0347241 A1
(43) Pub. Date: Oct. 17, 2024

(54) METHOD FOR MANUFACTURING Mn-Bi-BASED RESIN MAGNET, AND Mn-Bi-BASED RESIN MAGNET MANUFACTURED THEREFROM

(71) Applicant: KOREA INSTITUTE OF MATERIALS SCIENCE, Changwon-si, Gyeongsangnam-do (KR)

(72) Inventors: Chul Jin CHOI, Changwon-si, Gyeongsangnam-do (KR); Jong Woo KIM, Changwon-si, Gyeongsangnam-do (KR); Ji Hoon PARK, Changwon-si, Gyeongsangnam-do (KR); Nam Kyu KIM, Changwon-si, Gyeongsangnam-do (KR); Han kuk JEON, Sacheon-si, Gyeongsangnam-do (KR)

(21) Appl. No.: 18/701,081

(22) PCT Filed: Jul. 15, 2022
(86) PCT No.: PCT/KR2022/010393

§ 371 Date: Apr. 12, 2024

(30) Foreign Application Priority Data
Oct. 14, 2021 (KR) 10-2021-0136853

(51) Int. Cl. H01F 1/047; B22F 1/16; C08K 3/08; H01F 41/02

(52) U.S. Cl. CPC H01F 1/047; C08K 3/08; H01F 41/0266; B22F 1/16; C08K 2003/0837; C08K 2201/01

(57) ABSTRACT

The present disclosure provides a method for preparing a Mn—Bi based resin magnet, which can provide a Mn—Bi based resin magnet with excellent magnetic properties by forming a polymer coating on the surface of a Mn—Bi based magnetic phase powder, and a Mn—Bi based resin magnet prepared therefrom.

### TECHNICAL FIELD

This specification claims priority to and the benefit of Korean Patent Application No. 10-2021-0136853 filed in the Korean Intellectual Property Office on Oct. 14, 2021, and the entire contents thereof are included in the present disclosure.

The present disclosure relates to a method for preparing a Mn—Bi based resin magnet and the Mn—Bi based resin magnet prepared therefrom. Specifically, it relates to a method for preparing a Mn—Bi based resin magnet with excellent magnetic properties and the Mn—Bi based resin magnet prepared therefrom.

### BACKGROUND ART

Due to the depletion of fossil fuels and environmental pollution problems, interest in green energy to solve these problems is increasing. Accordingly, the demand for high-performance permanent magnets used in eco-friendly wind power generators, electric and hybrid vehicles, etc. is rapidly increasing.

Permanent magnets are applied in a wide range of fields, including electronic device, information and communication, medical, and machine tool fields, and industrial automobile motors. In particular, expectations for the development of permanent magnets with excellent characteristics are increasing due to the increase in the spread of electric vehicles and the demand for energy saving and improved power generation efficiency in the industrial fields.

However, rare earth elements, which are currently widely used in the permanent magnet field, are entirely dependent on imports, and as countries with rare earth resources are turning rare earth elements into strategic materials, the issue of price and supply instability is becoming a major issue. In addition, the use of rare earth permanent magnets is limited in high temperature applications such as the hybrid and electric vehicle motors due to the rapid magnetic properties decreases in high temperature regimes.

Therefore, the research on permanent magnets with high coercivity in high temperature applications without using rare earth elements has been actively conducted recently, mainly in the United States, China, and Japan. Since Mn-based permanent magnets among non-rare earth permanent magnets, especially Mn—Bi based permanent magnets, have a theoretical maximum energy product reaching to 18 MGOe and have magnetic properties of increasing coercivity as the temperature rises, they are a strong candidate to replace existing permanent magnets in high temperature applications.

However, since ignition caused by contact with air during the process due to the high reactivity of Mn—Bi in preparing such Mn—Bi based permanent magnets, loss of powder thereby, deterioration of magnetic properties due to oxidation, etc. lead to limitations in application due to the decline in industrial usability, a method of easily preparing the Mn—Bi based permanent magnets is absolutely necessary.

### DISCLOSURE

### Technical Problem

The technical problem to be achieved by the present disclosure is to provide a method for preparing a Mn—Bi based resin magnet that minimizes the deterioration of the properties of Mn—Bi based magnetic phase powder and to provide a Mn—Bi based resin magnet with excellent magnetic properties prepared therefrom.

However, the problem to be solved by the present disclosure is not limited to the problems mentioned above, and other problems not mentioned will be clearly understood by those skilled in the art from the following description.

### Technical Solution

According to one aspect of the present disclosure, there is provided a method for preparing a Mn—Bi based resin magnet, including steps of: preparing a Mn—Bi based magnetic phase powder whose surface is coated with a non-conductive polymer; and pressure-molding the Mn—Bi based magnetic phase powder whose surface is coated with the non-conductive polymer, wherein 0.5 parts by weight to 5 parts by weight of the non-conductive polymer is contained in the mixture based on 100 parts by weight of the Mn—Bi based magnetic phase powder.

According to the other aspect of the present disclosure, there is provided a Mn—Bi based resin magnet which is prepared by the method and has a maximum magnetic energy product ((BH)ₘₐₓ) of 3 MGOe or more.

### Advantageous Effects

The method for preparing a Mn—Bi based resin magnet according to one embodiment of the present disclosure can prevent ignition of the magnetic phase powder during the process and minimize the degradation of properties by protecting the Mn—Bi based magnetic phase powder by forming a polymer coating on the surface of the Mn—Bi based magnetic phase powder.

The method for preparing a Mn—Bi based resin magnet according to one embodiment of the present disclosure can provide a Mn—Bi based resin magnet that is excellent in magnetic properties especially even at high temperatures while ensuring the stability of the Mn—Bi based magnetic phase powder by including a small amount of polymer.

The method for preparing a Mn—Bi based resin magnet according to one embodiment of the present disclosure can uniformly form a polymer coating on the surface of the Mn—Bi based magnetic phase powder.

The Mn—Bi based resin magnet according to one embodiment of the present disclosure can be very excellent in magnetic properties such as maximum magnetic energy product.

The effects of the present disclosure are not limited to the effects described above, and effects not mentioned will be clearly understood by those skilled in the art from this specification.

### BRIEF DESCRIPTION OF DRAWINGS

FIG. 1 shows a magnetic hysteresis curve of the Mn—Bi based magnetic phase powder prepared in Preparation Example 1.

FIG. 2 shows a magnetic hysteresis curve of the coated Mn—Bi based magnetic phase powder prepared in Preparation Example 2.

FIG. 3 shows a magnetic hysteresis curve of the coated Mn—Bi based magnetic phase powder prepared in Preparation Example 3.

FIG. 4 shows a magnetic hysteresis curve of the coated Mn—Bi based magnetic phase powder prepared in Preparation Example 4.

FIG. 5 shows a magnetic hysteresis curve of the coated Mn—Bi based magnetic phase powder prepared in Preparation Example 5.

FIG. 6 shows a magnetic hysteresis curve of the Mn—Bi based resin magnet prepared in Example 1.

FIG. 7 shows a magnetic hysteresis curve of the Mn—Bi based resin magnet prepared in Example 2.

FIG. 8 shows a magnetic hysteresis curve of the Mn—Bi based resin magnet prepared in Example 3.

FIG. 9 shows a magnetic hysteresis curve of the Mn—Bi based resin magnet prepared in Example 4.

FIG. 10 shows a magnetic hysteresis curve of the Mn—Bi based resin magnet prepared in Example 5.

FIG. 11 shows a magnetic hysteresis curve of the Mn—Bi based magnet prepared in Comparative Example 1.

FIG. 12 shows a magnetic hysteresis curve of the Mn—Bi based resin magnet prepared in Preparation Example 6.

### BEST MODE

In this specification, when a part “includes” a certain component, this means that the part may further include other components rather than excluding other components, unless specifically stated to the contrary.

Throughout this specification, when a member is said to be located “on” another member, this includes not only the case where the member is in contact with the other member, but also the case where another member exists between the two members.

Throughout the specification of this application, the term “Mn—Bi based resin magnet” is a Mn—Bi based resin magnet containing resin, and may specifically mean a Mn—Bi based magnet containing a Mn—Bi based magnetic phase powder having resin coated on the surface thereof.

Hereinafter, the present disclosure will be described in more detail.

According to one embodiment of the present disclosure, there is provided a method for preparing a Mn—Bi based resin magnet, including steps of: preparing a Mn—Bi based magnetic phase powder whose surface is coated with a non-conductive polymer; and pressure-molding the Mn—Bi based magnetic phase powder whose surface is coated with the non-conductive polymer, wherein 0.5 parts by weight to 5 parts by weight of the non-conductive polymer is contained in the mixture based on 100 parts by weight of the Mn—Bi based magnetic phase powder.

The method for preparing a Mn—Bi based resin magnet according to one embodiment of the present disclosure may minimize deterioration in properties of the magnetic phase powder during the process by protecting the Mn—Bi based magnetic phase powder by forming a uniform polymer coating on the surface of a Mn—Bi based magnetic phase powder, and may provide a Mn—Bi based resin magnet that is excellent in magnetic properties especially at high temperatures while ensuring the stability of the Mn—Bi based magnetic phase powder by including a small amount of polymer.

Hereinafter, a method for preparing a Mn—Bi based resin magnet according to one embodiment of the present disclosure will be described in detail in order.

First, a Mn—Bi based magnetic phase powder may be prepared. The Mn—Bi based magnetic phase powder may be purchased commercially, and may also be prepared and used directly using a method widely used in the relevant technical field.

According to one embodiment of the present disclosure, the method for preparing a Mn—Bi based magnetic phase powder itself is not limited, and the Mn—Bi based magnetic phase powder may be prepared by, for example, the following method.

According to one embodiment of the present disclosure, the step of preparing a Mn—Bi based magnetic phase powder may include steps of: manufacturing a Mn—Bi based magnetic phase alloy; pulverizing the Mn—Bi based magnetic phase alloy to prepare a Mn—Bi based magnetic phase coarse powder; and micronizing the Mn—Bi based magnetic phase coarse powder to prepare a Mn—Bi based magnetic phase powder.

According to one embodiment of the present disclosure, the Mn—Bi based magnetic phase alloy may be manufactured first. Specifically, a raw material containing a Mn-based material and a Bi-based material may be melted by an induction heating melting method to prepare a mixed melt, the mixed melt may be rapidly solidified to manufacture a Mn—Bi based master alloy (ingot), and then the Mn—Bi based master alloy may be annealed to manufacture a Mn—Bi based magnetic phase alloy.

According to one embodiment of the present disclosure, when preparing the mixed melt, the melting may be performed at a temperature of 545K to 1500K. The melting may be performed by one or more methods selected from an induction heating process, an arc-melting process, a mechanochemical process, and a sintering process.

According to one embodiment of the present disclosure, the raw material may be a powder phase, and specifically, the Mn-based material and Bi-based material may be a Mn metal powder and a Bi metal powder, and the raw material may contain other metallic materials and/or non-metallic materials, and inevitable impurities in addition to the Mn-based material and Bi-based material. That is, the raw material may be prepared by mixing a Mn metal powder and a Bi metal powder.

According to one embodiment of the present disclosure, the raw material may further contain other materials in addition to the Mn-based material and Bi-based material. Specifically, the raw material may contain one or more of other metallic materials and/or non-metallic materials such as Sn, Mg, and Sb in addition to the Mn-based material and Bi-based material, and the types and addition amounts of such metallic elements and non-metallic elements may be adjusted depending on the purpose of the resin magnet prepared.

According to one embodiment of the present disclosure, in manufacturing a Mn—Bi based magnetic phase alloy by annealing the mixed melt, the annealing may be performed at a temperature of 400K or higher to 700K or lower for 24 hours or more to 96 hours or less in an inert atmosphere, for example, an Ar atmosphere. For example, the annealing may be performed at a temperature of 500K or higher to 600K or lower for 48 hours or more to 84 hours or less, specifically, at a temperature of 573K for 72 hours. The Mn—Bi based magnetic phase alloy may be obtained through the annealing.

According to one embodiment of the present disclosure, the Mn—Bi based magnetic phase alloy may have a composition of MnₓBi₁₋ₓ, wherein x may be 0.4 to 0.7, 0.5 to 0.6, or 0.55 to 0.56. The composition of the magnetic phase alloy may be adjusted by preparing a raw material to satisfy the composition based on the atomic ratio of Mn and Bi, and specifically, it may be adjusted by preparing the raw material by mixing a Mn metal powder and a Bi metal powder in consideration of the atomic ratio of Mn and Bi to satisfy the composition.

According to one embodiment of the present disclosure, after that, a Mn—Bi based magnetic phase coarse powder may be prepared by pulverizing the Mn—Bi based magnetic phase alloy. “Coarse powder” may mean a powder with large and coarse particles. This may be a step of pulverizing the alloy as an intermediate step before micronizing the Mn—Bi based magnetic phase alloy.

The pulverizing may be performed using a general pulverizing method in the relevant technical field. For example, a coarse powder of less than a certain size, for example, a particle diameter of about 25 μm to 150 μm or less, may be obtained by performing crushing and sieving.

According to one embodiment of the present disclosure, a Mn—Bi based magnetic phase powder may be prepared by micronizing the Mn—Bi based magnetic phase coarse powder. For example, the Mn—Bi based magnetic phase powder may have a particle diameter of 2.5 μm to 4 μm in the case of D₅₀.

That is, a Mn—Bi based magnetic phase powder that satisfies the above particle size distribution may be prepared by micronizing a coarse powder with a particle diameter of about 25 μm to 150 μm through ball milling.

According to one embodiment of the present disclosure, the micronizing step may be performed by ball milling the Mn—Bi based magnetic phase coarse powder for 3 to 21 hours, the ball milling may be low-energy ball milling, may be performed under conditions of 100 rpm to 300 rpm, and the balls may be (3 to (7. In addition, ball milling may be performed by introducing the balls so that the weight ratio of the Mn—Bi based magnetic phase coarse powder to the balls is about 10:1.

According to one embodiment of the present disclosure, the method may further include a step of demagnetizing the Mn—Bi based magnetic phase powder before the step of preparing the mixture using the Mn—Bi based magnetic phase powder as described later.

Meanwhile, since the powder particles in the Mn—Bi based magnetic phase powder may each be magnetic and aggregate, and when a non-conductive polymer coating is formed in the aggregated state, the coating is not individually formed on the surface of each powder particle, and thus a homogeneous coating is not achieved, so the effect of protecting the magnetic powder may be somewhat inferior, a demagnetization step may be further included before the step of preparing the mixture as described later. A powder particle aggregate may be separated into individual particles through the demagnetization process.

According to one embodiment of the present disclosure, the demagnetization step may be performed under conditions in which the Mn—Bi based magnetic phase powder is charged into a sealed container and a magnetic field is applied while changing direction and intensity. Specifically, the demagnetization step may be performed by repeating the process of applying a magnetic field in one direction to the Mn—Bi based magnetic phase powder, then applying a magnetic field with a smaller intensity in the opposite direction, and then applying a magnetic field with a further smaller intensity in one direction.

According to one embodiment of the present disclosure, the demagnetization step may be repeatedly changing the direction of the magnetic field applied to the Mn—Bi based magnetic phase powder, and at the same time gradually reducing the intensity of the magnetic field. Specifically, the direction of the magnetic field may repeatedly change one direction and the opposite direction, and the intensity of the magnetic field may be reduced at a reduction rate of about 80% to 99%, or about 95%.

For example, after charging the Mn—Bi based magnetic phase powder into a sealed container, the process of applying a magnetic field of 2.5 T, then applying a magnetic field of −2.38 T, which has the opposite direction and an intensity of about 95% of 2.5 T, and then applying a magnetic field of 2.26 T, which has an intensity of about 95% of 2.38 T again, and applying a magnetic field of −2.14 T, which has the opposite direction and an intensity of about 95% of 2.26 T, may be repeatedly performed.

According to one embodiment of the present disclosure, the demagnetization process may be performed for a long time so that the Mn—Bi based magnetic phase powder may be sufficiently dispersed, and may be performed for about 10 to 20 minutes.

According to one embodiment of the present disclosure, the sealed container is not particularly limited and may be, for example, a graphite tube.

According to one embodiment of the present disclosure, the Mn—Bi based magnetic phase powder whose surface is coated with the non-conductive polymer may be prepared by steps of: preparing a mixture containing a Mn—Bi based magnetic phase powder, a non-conductive polymer, and a solvent; and evaporating the solvent.

According to one embodiment of the present disclosure, a mixture containing the Mn—Bi based magnetic phase powder prepared as described above, a non-conductive polymer, and a solvent is prepared.

According to one embodiment of the present disclosure, the non-conductive polymer is contained in an amount of 0.5 parts by weight to 5 parts by weight based on 100 parts by weight of the Mn—Bi based magnetic phase powder. Specifically, the non-conductive polymer may be contained in the mixture in an amount of 0.5 parts by weight to 5 parts by weight, 0.5 parts by weight to 4 parts by weight, 0.5 parts by weight to 3 parts by weight, 0.5 parts by weight to 2 parts by weight, or 0.5 parts by weight to 1 part by weight with respect to 100 parts by weight of the Mn—Bi based magnetic phase powder.

When the non-conductive polymer is contained within the above-described amount range, the magnetic properties may be excellent since there is less deterioration in the magnetic properties of the Mn—Bi based magnetic phase powder as a raw material, and the content of the non-conductive polymer in the Mn—Bi based resin magnet to be prepared is small.

According to one embodiment of the present disclosure, the weight ratio of the organic solvent to the non-conductive polymer contained in the mixture may be 1:0.1 to 1:0.7, but is not limited thereto.

According to one embodiment of the present disclosure, the organic solvent may be an alcohol-based solvent, a ketone-based solvent, an aldehyde-based solvent, an ether-based solvent, an ester-based solvent, a glycol-based solvent, a hydrocarbon-based solvent, etc., may vary depending on the type of the non-conductive polymer, may include a mixture of one or more solvents, and may especially be an alcohol-based solvent.

According to one embodiment of the present disclosure, the non-conductive polymer is not particularly limited as long as it has insulating properties, may be a polyamide-based polymer, a polyimide-based polymer, a polyester-based polymer, a silicone-based polymer, a polyacrylic polymer, etc., and may include a mixture of one or more polymers.

According to one embodiment of the present disclosure, the step of preparing the mixture may be performed at a temperature of 20° C. to 80° C., and preferably may be performed at a temperature of 50° C. to 80° C. When preparing a mixture within the above temperature range, the non-conductive polymer may be well mixed with the Mn—Bi based magnetic phase powder in a state in which it is homogeneously dissolved in the solvent while controlling volatilization of the solvent.

According to one embodiment of the present disclosure, the solvent in the prepared mixture is evaporated to prepare a Mn—Bi based magnetic phase powder whose surface is coated with a non-conductive polymer. When the solvent is evaporated, a coating layer containing a non-conductive polymer may be formed on the outer surface of the Mn—Bi based magnetic phase powder. In this process, a uniform coating layer may be formed on the surface of the Mn—Bi based magnetic phase powder, and the coating layer protects the Mn—Bi based magnetic phase powder from the outside so that problems such as ignition, and deterioration due to oxidation during the process may be prevented, and resin magnets may be prepared stably.

According to one embodiment of the present disclosure, the evaporation may be performed under vacuum conditions. When preparing a Mn—Bi based magnetic phase powder whose surface is coated with a non-conductive polymer by evaporating the solvent under the above vacuum conditions, the solvent may be quickly evaporated, and deterioration of magnetic properties may be minimized while preventing ignition by minimizing contact of the Mn—Bi based magnetic phase powder with air and avoiding exposure of the Mn—Bi based magnetic phase powder to high temperatures.

According to one embodiment of the present disclosure, the Mn—Bi based magnetic phase powder whose surface is coated with the non-conductive polymer prepared above is pressure-molded.

According to one embodiment of the present disclosure, the pressure molding may be performed at a temperature of 20° C. to 350° C., preferably 250° C. to 350° C., or 250° C. to 310° C. When pressure molding is performed within the above-described temperature range, the density of the resin magnet may increase due to the binding effect due to the flow of the polymer coated on the surface of the Mn—Bi based magnetic phase powder, and the sintering effect due to high temperature pressurization. Generally, in the case of pressure molding of magnetic particles, there is a phenomenon of decreasing the alignment degree and coercivity due to the formation of local antiferromagnetism due to the reduced distance between particles, but in the case of resin magnets, there is also the effect of minimizing the decrease thereof due to antiferromagnetism due to the isolation effect between particles.

According to one embodiment of the present disclosure, the pressure molding may be performed for 3 to 15 minutes. When pressure molding is performed for a time within the above-described range, the effect of sintering, such as improvement in density, may be maximized by sufficiently securing the fluidity of the polymer and Mn—Bi based magnetic phase powder at high temperatures. However, if the pressure molding time is excessively lengthened, the properties of the Mn—Bi based magnetic phase powder may be deteriorated due to exposure to high temperatures and a decrease in the coercivity may be significantly exhibited due to grain growth, so selection of an appropriate time is necessary.

According to one embodiment of the present disclosure, the pressure molding may be performed by applying a pressure of 50 MPa to 500 MPa to the mixture. When pressure molding is performed at a pressure within the above-described range, the density and strength of the resin magnet may be improved, and the density and strength each contribute to the maximum magnetic energy product and improvement in usability, and a permanent magnet with excellent magnetic properties may be prepared as a result.

According to one embodiment of the present disclosure, it may be prepared by the above method and have a maximum magnetic energy product ((BH)ₘₐₓ) of 3 MGOe or more. Preferably, a Mn—Bi based resin magnet having 3 MGOe to 12 MGOe, 3 MGOe to 10 MGOe, or 5 MGOe to 9 MGOe may be provided. The Mn—Bi based resin magnet according to one embodiment of the present disclosure may be very excellent in magnetic properties such as maximum magnetic energy product, and is prepared by using specifically the Mn—Bi based magnetic phase powder whose surface is coated with a non-conductive polymer, as a raw material, and thus the magnetic properties of the Mn—Bi based magnetic phase powder are less deteriorated so that the magnetic properties of the Mn—Bi based resin magnet may be excellent.

### MODE FOR INVENTION

Hereinafter, the present disclosure will be described in detail with reference to Examples in order to explain it specifically. However, the embodiments according to the present disclosure may be modified into various other forms, and the scope of the present disclosure is not construed as being limited to the Examples described below. The Examples of this specification are provided to more completely explain the present disclosure to those skilled in the art.

### Preparation Example 1

First, a manganese (Mn) metal powder (purchased from: iTASCO, purity: 99.95%) and a bismuth (Bi) metal powder (purchased from: Aldrich, purity: 99.999%) were mixed at a weight ratio of 56:44, and this mixed powder was charged into a furnace (manufacturer name: Indutherm, device name: Induction melter, model name: MC 20V) and then melted through an induction heating method. That is, the temperature of the furnace was instantly raised to 1200° C. to prepare a mixed melt. The mixed melt was annealed in an Ar atmosphere at a temperature of 573K for 72 hours to form a Mn—Bi based magnetic phase alloy.

The Mn—Bi based magnetic phase alloy was pulverized using a hand mill and sieved using a sieve (ASTM mesh No. 500) to obtain a Mn—Bi based magnetic phase coarse powder of 150 μm or less. The Mn—Bi based magnetic phase coarse powder was subjected to low-energy ball milling at 175 rpm for 6 hours to obtain Mn—Bi based magnetic phase powder.

### Preparation Example 2

A mixture was prepared by mixing 10 g of the Mn—Bi based magnetic phase powder prepared in Preparation Example 1 with a non-conductive polymer solution containing 0.0669 g of ZZ3000P (polyamide 12), 0.004 g of silicone oil (ethane-based wax), and 0.016 g of Irganox 1010 (C₇₃H₁₀O₁₂) as a non-conductive polymer, and 0.1974 g of ethanol as a solvent.

A coated Mn—Bi based magnetic phase powder was prepared by evaporating the solvent from the mixture in a vacuum chamber using a rotary pump for 2 hours.

### Preparation Example 3

10 g of the Mn—Bi based magnetic phase powder prepared in Preparation Example 1 was charged into a graphite tube, and then, using a magnetic field of 2.5 T as the initial applied magnetic field, the direction was reversed, and the magnetic field intensity was repeated 170 times at a reduction rate of 95% to perform the demagnetization for 15 minutes.

Thereafter, a mixture was prepared by mixing 10 g of the demagnetized Mn—Bi based magnetic phase powder with a non-conductive polymer solution containing 0.0669 g of ZZ3000P (polyamide 12), 0.004 g of silicone oil (ethane-based wax), and 0.016 g of Irganox 1010 (C₇₃H₁₀O₁₂) as a non-conductive polymer, and containing 0.1974 g of ethanol as a solvent.

The solvent was evaporated from the mixture under vacuum conditions for 2 hours to prepare a coated Mn—Bi based magnetic phase powder.

### Preparation Example 4

10 g of the Mn—Bi based magnetic phase powder prepared in Preparation Example 1 was charged into the graphite tube, and then, using a magnetic field of 2.5 T as the initial applied magnetic field, the direction was reversed, and the magnetic field intensity was reduced at a reduction rate of 95% to perform the demagnetization for 15 minutes.

Thereafter, a mixture was prepared by mixing 10 g of the demagnetized Mn—Bi based magnetic phase powder with a non-conductive polymer solution containing 0.1338 g of ZZ3000P (polyamide 12), 0.008 g of silicone oil (ethane-based wax), and 0.032 g of Irganox 1010 (C₇₃H₁₀O₁₂) as a non-conductive polymer, and containing 0.3948 g of ethanol as a solvent.

The mixture was dried under vacuum conditions for 2 hours to prepare a coated Mn—Bi based magnetic phase powder.

### Preparation Example 5

10 g of the Mn—Bi based magnetic phase powder prepared in Preparation Example 1 was charged into the graphite tube, and then, using a magnetic field of 2.5 T as the initial applied magnetic field, the direction was reversed, and the magnetic field intensity was maintained at a reduction rate of 95% to perform the demagnetization for 15 minutes.

Thereafter, a mixture was prepared by mixing 10 g of the demagnetized Mn—Bi based magnetic phase powder with a non-conductive polymer solution containing 0.2675 g of ZZ3000P (polyamide 12), 0.016 g of silicone oil (ethane-based wax), and 0.064 g of Irganox 1010 (C₇₃H₁₀O₁₂) as a non-conductive polymer, and containing 0.7895 g of ethanol and 0.075 g of toluene as solvents.

The solvent was evaporated from the mixture under vacuum conditions for 2 hours to prepare a coated Mn—Bi based magnetic phase powder.

### Preparation Example 6

A mixture was prepared by mixing 10 g of the Mn—Bi based magnetic phase powder prepared in Preparation Example 1 with a non-conductive polymer solution containing 0.535 g of ZZ3000P (polyamide 12), 0.032 g of silicone oil (ethane-based wax), and 0.128 g of Irganox 1010 (C₇₃H₁₀O₁₂) as a non-conductive polymer, and containing 0.15 g of toluene and 1.579 g of ethanol as solvents.

The mixture was naturally dried at room temperature to prepare a Mn—Bi based resin magnet.

### Example 1

The coated Mn—Bi based magnetic phase powder prepared in Preparation Example 2 was pressed at a temperature of 200° C. and a pressure of 100 MPa for 5 minutes to prepare a Mn—Bi based resin magnet.

### Example 2

A Mn—Bi based resin magnet was prepared in the same manner as in Example 1 except that the demagnetized coated Mn—Bi based magnetic phase powder prepared in Preparation Example 3 was used.

### Example 3

A Mn—Bi based resin magnet was prepared in the same manner as in Example 1 except that the demagnetized coated Mn—Bi based magnetic phase powder prepared in Preparation Example 4 was used.

### Example 4

The coated Mn—Bi based magnetic phase powder prepared in Preparation Example 5 was pressed at a temperature of 310° C. and a pressure of 100 MPa for 5 minutes to prepare a Mn—Bi based resin magnet.

### Example 5

The coated Mn—Bi based magnetic phase powder prepared in Preparation Example 5 was pressed at a temperature of 150° C. and a pressure of 100 MPa for 5 minutes to prepare a Mn—Bi based resin magnet.

### Comparative Example 1

The Mn—Bi based magnetic phase powder prepared in Preparation Example 1 was pressed at a temperature of 300° C. and a pressure of 100 MPa for 5 minutes to prepare a Mn—Bi based magnet.

### Experimental Example: Magnetic Property Evaluation

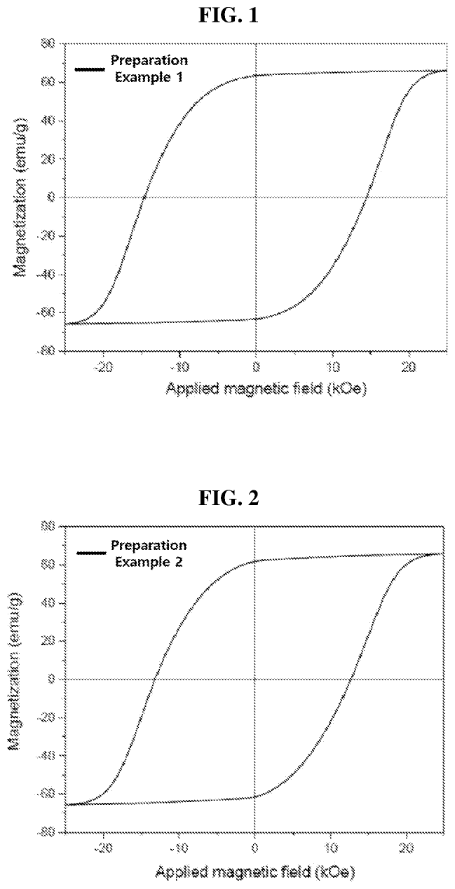

Magnetic hysteresis curves of the Mn—Bi based magnetic phase powders prepared in Preparation Examples 1 to 5, the Mn—Bi based resin magnets prepared in Examples 1 to 5 and Preparation Example 6, and the Mn—Bi based magnet prepared in Comparative Example 1 were measured with Lakeshore's VSM equipment at a temperature of 300K under a magnetic field of −2.5 T to 2.5 T. The magnetic hysteresis curves and measurement results of each Mn—Bi based magnetic phase powder, resin magnet, or magnet measured are shown in FIGS. 1 to 12.

FIG. 1 shows a magnetic hysteresis curve of the Mn—Bi based magnetic phase powder prepared in Preparation Example 1.

FIG. 2 shows a magnetic hysteresis curve of the coated Mn—Bi based magnetic phase powder prepared in Preparation Example 2.

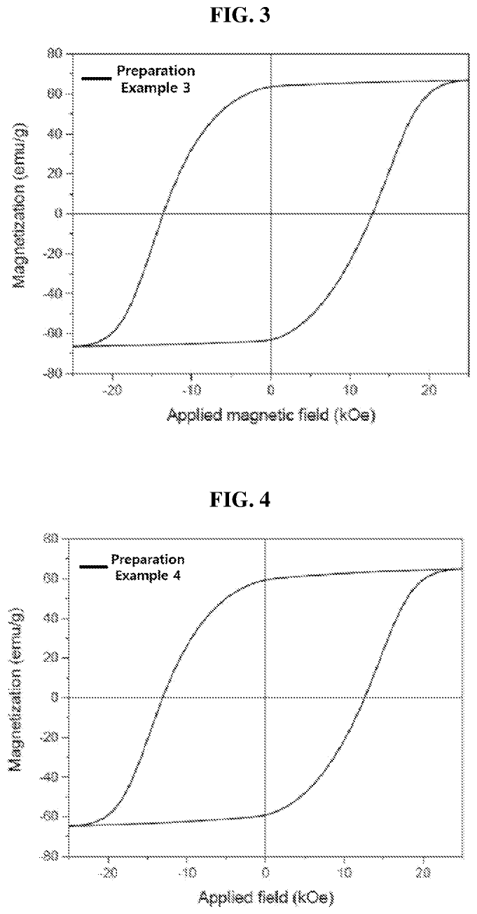

FIG. 3 shows a magnetic hysteresis curve of the coated Mn—Bi based magnetic phase powder prepared in Preparation Example 3.

FIG. 4 shows a magnetic hysteresis curve of the coated Mn—Bi based magnetic phase powder prepared in Preparation Example 4.

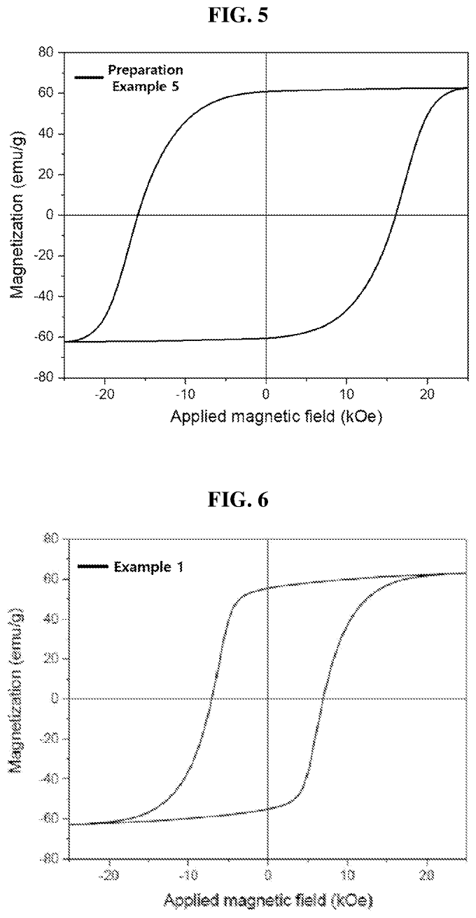

FIG. 5 shows a magnetic hysteresis curve of the coated Mn—Bi based magnetic phase powder prepared in Preparation Example 5.

FIG. 6 shows a magnetic hysteresis curve of the Mn—Bi based resin magnet prepared in Example 1.

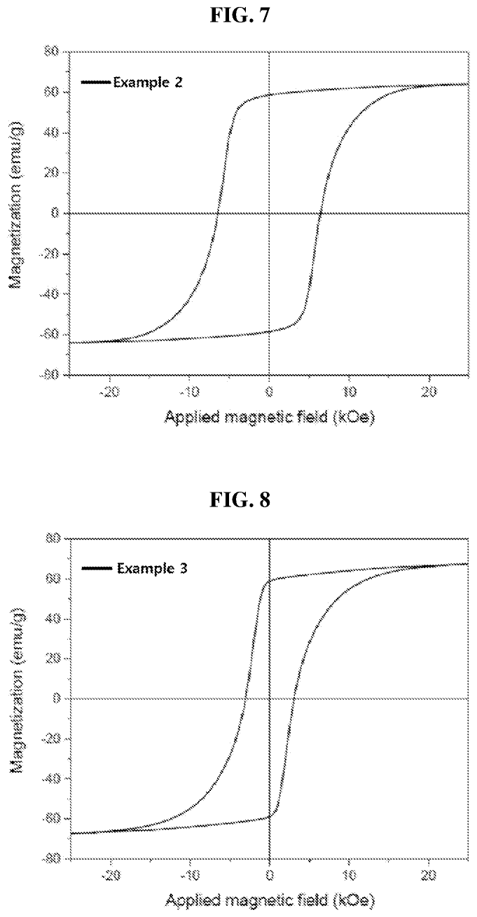

FIG. 7 shows a magnetic hysteresis curve of the Mn—Bi based resin magnet prepared in Example 2.

FIG. 8 shows a magnetic hysteresis curve of the Mn—Bi based resin magnet prepared in Example 3.

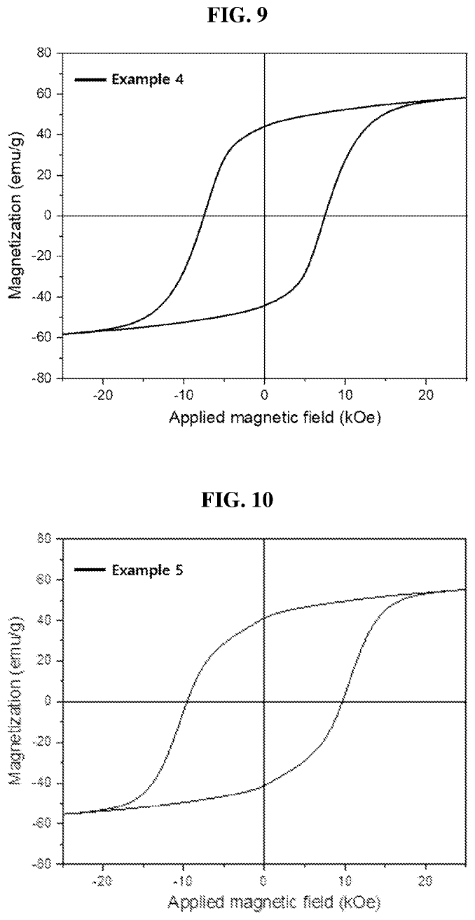

FIG. 9 shows a magnetic hysteresis curve of the Mn—Bi based resin magnet prepared in Example 4.

FIG. 10 shows a magnetic hysteresis curve of the Mn—Bi based resin magnet prepared in Example 5.

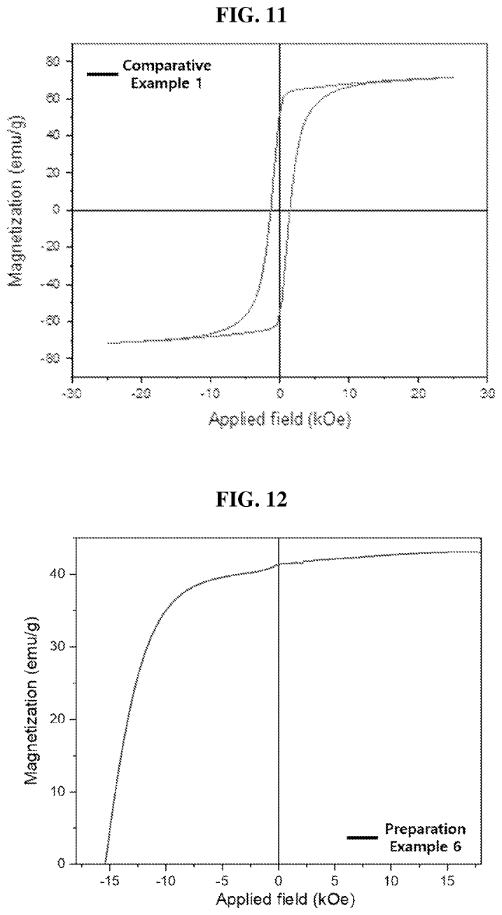

FIG. 11 shows a magnetic hysteresis curve of the Mn—Bi based magnet prepared in Comparative Example 1.

FIG. 12 shows a magnetic hysteresis curve of the Mn—Bi based resin magnet prepared in Preparation Example 6.

Densities of the Mn—Bi based magnetic phase powders prepared in Preparation Examples 1 to 5 above, the Mn—Bi based resin magnets prepared in Examples 1 to 5 and Preparation Example 6, and the Mn—Bi based magnet prepared in Comparative Example 1, and residual magnetization (Mr), saturation magnetization (Ms), alignment degree (Mr/Ms), coercivity (Hc), and maximum magnetic energy product ((BH)max) of the Mn—Bi based magnetic phase powders prepared in Preparation Examples 1 to 5 above, the Mn—Bi based resin magnets prepared in Examples 1 to 5 and Preparation Example 6 above, and the Mn—Bi based magnet prepared in Comparative Example 1 were measured from the results of FIGS. 1 to 12, and are shown in Table 1 below.

TABLE 1

| | | | Mr/ | | | |
|---|---|---|---|---|---|---|
| | Mr | Ms | Ms*100 | Hc | ρ | (BH)ₘₐₓ |
| | (emu/g) | (emu/g) | (%) | (kOe) | (g/cm³) | (MGOe) |
| Preparation | 63.5 | 66.1 | 96.1 | 14.7 | 8.9 | 11.49 |
| Example 1 | | | | | | |
| (Powder) | | | | | | |
| Preparation | 61.6 | 65.8 | 93.6 | 12.8 | 8.733 | 9.86 |
| Example 2 | | | | | | |
| (Powder) | | | | | | |
| Preparation | 63.7 | 66.8 | 95.4 | 13.4 | 8.733 | 10.70 |
| Example 3 | | | | | | |
| (Powder) | | | | | | |
| Preparation | 59.2 | 64.9 | 91.2 | 12.8 | 8.574 | 8.90 |
| Example 4 | | | | | | |
| (Powder) | | | | | | |
| Preparation | 60.8 | 62.6 | 97.12 | 15.9 | 6.810 | 6.57 |
| Example 5 | | | | | | |
| (Powder) | | | | | | |
| Example 1 | 55.3 | 63.0 | 87.8 | 7.02 | 8.315 | 7.4 |
| Example 2 | 58.6 | 64.1 | 91.4 | 6.41 | 8.494 | 8.75 |
| Example 3 | 58.8 | 67.4 | 87.2 | 3.06 | 8.292 | 4.77 |
| Example 4 | 44.0 | 58.2 | 75.6 | 7.49 | 6.965 | 3.16 |
| Example 5 | 41.2 | 55.3 | 74.5 | 9.59 | 6.635 | 2.48 |
| Comparative | 53.4 | 71.6 | 74.5 | 1.361 | 8.54 | 1.44 |
| Example 1 | | | | | | |
| Preparation | 45.8 | 48.1 | 95.2 | 15.1 | 5.59 | 1.08 |
| Example 6 | | | | | | |

Referring to Table 1 and FIGS. 1 to 3, it can be confirmed that the magnetic properties of the magnetic powder of Preparation Example 3 were further improved compared to the magnetic powder of Preparation Example 2 by performing a demagnetization process on the powder.

Referring to Table 1 above and FIGS. 3 to 5, it can be confirmed that the magnetic properties of the prepared magnetic phase powder are excellent as the content of the non-conductive polymer is less. This is an inevitable result of the inclusion of polymers, which are non-magnetic materials.

Referring to Table 1 above and FIGS. 6 and 7, it can be confirmed that resin magnets with more excellent magnetic properties may be prepared by using powder that has undergone a demagnetization process. This corresponds to the contents that were confirmed from FIGS. 1 to 3 above.

Referring to Table 1 above and FIGS. 7 and 8, it can be confirmed that the magnetic properties of the prepared resin magnet are excellent as the content of the non-conductive polymer is small. This is an inevitable result of the inclusion of polymers, which are non-magnetic materials, and furthermore corresponds to the contents that were confirmed from FIGS. 3 to 5 above.

Referring to Table 1 above and FIGS. 9 and 10, it can be confirmed that the magnetic properties of the resin magnet prepared by performing pressure molding at a higher temperature are more excellent.

Referring to Table 1 above and FIG. 11, it can be seen that when it is not coated with a non-conductive polymer, the magnetic properties of the bulk magnet are poor due to deterioration of the magnetic phase powder during the heat treatment process for bulking.

In addition, referring to Table 1 above and FIG. 12, it can be confirmed that when the content of the non-conductive polymer is outside the scope of the present disclosure, the magnetic properties are significantly deteriorated.

Therefore, it can be seen that the Mn—Bi based resin magnet according to one embodiment of the present disclosure can maintain its magnetic properties even at high temperatures with little deterioration in magnetic properties.

Although the present disclosure has been described above with limited Examples, the present disclosure is not limited thereto, and it goes without saying that various modifications and variations can be made by those skilled in the art to which the present disclosure pertains within the equivalent scope of the technical idea of the present disclosure and the claims to be described below.

1. A method for preparing a Mn—Bi based resin magnet, comprising steps of:
preparing a Mn—Bi based magnetic phase powder whose surface is coated with a non-conductive polymer; and
pressure-molding the Mn—Bi based magnetic phase powder whose surface is coated with the non-conductive polymer,
wherein 0.5 parts by weight to 5 parts by weight of the non-conductive polymer is contained in the mixture based on 100 parts by weight of the Mn—Bi based magnetic phase powder.

2. The method of claim 1, wherein the Mn—Bi based magnetic phase powder whose surface is coated with the non-conductive polymer is prepared by steps of:
preparing a mixture containing a Mn—Bi based magnetic phase powder, a non-conductive polymer, and a solvent; and
evaporating the solvent.

3. The method of claim 2, wherein the step of preparing the mixture is performed at a temperature of 20° C. to 80° C.

4. The method of claim 2, wherein the evaporation is performed under vacuum conditions.

5. The method of claim 2, further comprising a step of demagnetizing the Mn—Bi based magnetic phase powder before the step of preparing the mixture.

6. The method of claim 5, wherein the demagnetization step is repeatedly changing the direction of the magnetic field applied to the Mn—Bi based magnetic phase powder, and at the same time gradually reducing the intensity of the magnetic field.

7. The method of claim 1, wherein the pressure molding is performed at a temperature of 20° C. to 350° C.

8. The method of claim 1, wherein the pressure molding is performed for 3 to 15 minutes.

9. The method of claim 1, wherein the pressure molding is performed by applying a pressure of 50 MPa to 500 MPa to the mixture.

10. A Mn—Bi based resin magnet which is prepared by the method according to claim 1, and has a maximum magnetic energy product ((BH)ₘₐₓ) of 3 MGOe or more.
